(19) United States
(12) Patent Application Publication
(10) Pub. No.: US 2018/0313224 A1
(43) Pub. Date: Nov. 1, 2018

(54) METHOD AND SYSTEM FOR IMPROVED DESIGN AND IMPLEMENTATION OF TURBOMACHINERY

(71) Applicant: General Electric Company, Schenectady, NY (US)

(72) Inventors: Subrat Nanda, Houston, TX (US); Kurt F. Waldner, Atlanta, GA (US); Matthew Thomas Krueger, Houston, TX (US)

(21) Appl. No.: 15/583,623

(22) Filed: May 1, 2017

(51) Int. Cl. F01D 21/00; F02C 6/18; F01D 15/10; G06N 7/00; G06F 17/50

(52) U.S. Cl. CPC F01D 21/003; F02C 6/18; F01D 15/10; F05D 2220/72; G06F 17/5009; F05D 2220/32; G06N 7/005

(57) ABSTRACT

A system includes a processor. The processor is configured to identify relevant factors related to a configuration of a power production system comprising a gas turbine system based at least on a fleet data for a fleet of the gas turbine system. The processor is further configured to build one or more risk models configured to derive a probability of achieving a performance level for the configuration based on the relevant factors. The processor is additionally configured to execute the risk models to derive an engineering recommendation, a commercial recommendation, or a combination thereof.

### BACKGROUND OF THE INVENTION

The invention relates generally to turbomachinery, and more particularly to a method and system for improved design and implementation of turbomachinery.

Turbomachinery, such as gas turbine systems, may provide for the generation of power. For example, the gas turbine systems typically include a compressor for compressing a working fluid, such as air, a combustor for combusting the compressed working fluid with fuel, and a turbine for turning the combusted fluid into a rotative power. For example, the compressed air is injected into a combustor, which heats the fluid causing it to expand, and the expanded fluid is forced through the gas turbine. The gas turbine may then convert the expanded fluid into rotative power, for example, by a series of blade stages. The rotative power may then be used to drive a load, which may include an electrical generator producing electrical power. The gas turbine engine may generate an amount of waste heat, which may be recovered via a steam turbine system. The steam turbine system may use steam generated via the gas turbine system exhaust (or via another source) to rotatively turn steam turbine blades. The steam turbine blades may be used to create rotative power that may then drive a second load. The second load may include a second electrical generator producing electrical power. It would be beneficial to improve the design and implementation of turbomachinery.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a processor. The processor is configured to identify relevant factors related to a configuration of a power production system comprising a gas turbine system based at least on a fleet data for a fleet of the gas turbine system. The processor is further configured to build one or more risk models configured to derive a probability of achieving a performance level for the configuration based on the relevant factors. The processor is additionally configured to execute the risk models to derive an engineering recommendation, a commercial recommendation, or a combination thereof.

In a second embodiment, a method includes identifying, via a processor, relevant factors related to a configuration of a power production system comprising a gas turbine system based at least on a fleet data for a fleet of the gas turbine system. The method further includes building, via the processor, one or more risk models configured to derive a probability of achieving a performance level for the configuration based on the relevant factors. The method also includes executing, via the processor, the risk models to derive an engineering recommendation, a commercial recommendation, or a combination thereof.

In a third embodiment, a non-transitory computer readable medium, comprises instructions that when executed by a processor, cause the processor to identify relevant factors related to a configuration of a power production system comprising a gas turbine system based at least on a fleet data for a fleet of the gas turbine system. The instructions further cause the processor to build one or more risk models configured to derive a probability of achieving a performance level for the configuration based on the relevant factors. The instructions also cause the processor to execute the risk models to derive an engineering recommendation, a commercial recommendation, or a combination thereof.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbomachinery;

FIG. 2 is a flow chart of a process useful in improving design and contracting operations for the turbomachinery of FIG. 1; and

FIG. 3 is a diagram of an embodiment of a graphical user interface (GUI) suitable for interfacing with the process of FIG. 2.

### DETAILED DESCRIPTION OF THE INVENTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

The embodiments described herein apply both design knowledge and data analysis (e.g., statistical analysis) for a faster derivation of overall availability, reliability, and/or operational capabilities of a system, such as a turbomachine system included in a power production system. Turbomachinery, such as a gas turbine, a steam turbine, or a combination thereof, may be designed and installed for a specific geographic location, desired operating parameters, and/or desired “up” time. For example, an existing gas turbine “frame” may be selected, and certain components installed (e.g., combustors, inlet guide vanes, controller, exhaust system, and so on) to meet the design and customer specifications. The power production system may then be installed with the designed gas turbine system suitable for meeting the design criteria for the specific geographic location. The manufacturer and/or installer of the power production system may then provide certain levels of service based on agreed upon operating parameters, “up” time, and so on.

Embodiments described herein include processes and systems to derive a set of design criteria suitable for meeting customer requirements and probabilities (e.g., risk) associated either meeting or not meeting the customer requirements. In certain embodiments, the derived probabilities or risks may be used to further improve the design. Additionally, the derived probabilities or risks may be used to better tailor certain contractual service agreements (CSAs) that may be provided by the manufacturer to the client detailing financial incentives or cost for meeting certain operational reliability, availability & operating criteria (e.g., power produced). Feedback techniques deliver the derived risks back to both design and commercial systems for improving design and for enhancing negotiation with new and existing customers, including CSA updates. The processes and systems may be implemented over the web or cloud computing, and may provide direct estimates of both financial and engineering risk of future turbomachinery operations. Statistical models and data analysis may be used to approximate impact to turbomachinery life due to, for example, duty cycle variations.

Engineering models, including statistical analysis models, visual inspection models, physics-based models, or a combination thereof, may be used to provide for engineering analysis of the performance and operational state of the turbomachinery and the turbomachinery components. Commercial models, including cost benefit analysis models, economic models, return on investment (ROI) models or a combination thereof, may be used to provide for commercial analysis of current and future impact associated with delivery of the turbomachinery as designed. Risk assessment models may also be used, including probabilistic risk assessment models, risk management models, or a combination thereof, suitable for enabling an approximate derivation of risk associated with operating the turbomachinery at a client sight. By analyzing the impact of the operating the turbomachinery at a specific client sight, and by providing for an approximate measure of risk associated with the turbomachinery, the systems and methods described herein may enable a more efficient utilization of turbomachinery, provide for lower costs, and increase the flexibility in providing CSAs to clients.

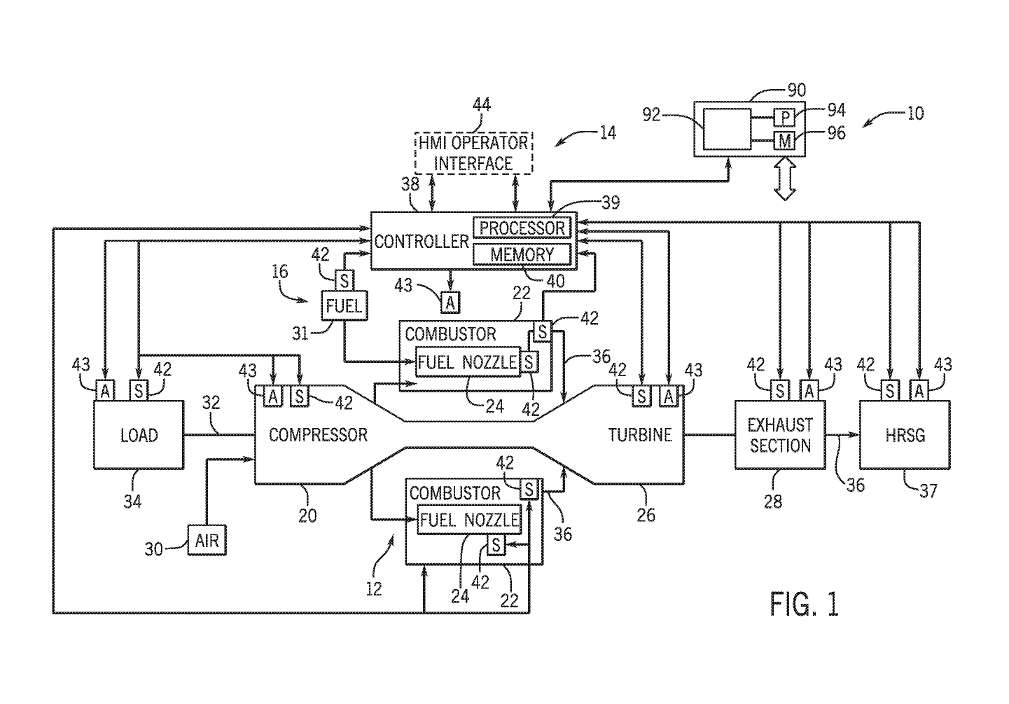

With the foregoing in mind, it may be useful to describe an embodiment of a turbomachinery incorporating techniques disclosed herein, such as a power production system 10 illustrated in FIG. 1. As illustrated in FIG. 1, the power production system 10 includes the gas turbine system 12, a monitoring and control system 14, and a fuel supply system 16. The gas turbine system 12 may include a compressor 20, combustion systems 22, fuel nozzles 24, a gas turbine 26, and an exhaust section 28. During operation, the gas turbine system 12 may pull air 30 into the compressor 20, which may then compress the air 30 and move the air 30 to the combustion system 22 (e.g., which may include a number of combustors). In the combustion system 22, the fuel nozzle 24 (or a number of fuel nozzles 24) may inject fuel that mixes with the compressed air 30 to create, for example, an air-fuel mixture.

The air-fuel mixture may combust in the combustion system 22 to generate hot combustion gases, which flow downstream into the turbine 26 to drive one or more turbine stages. For example, the combustion gases may move through the turbine 26 to drive one or more stages of turbine blades, which may in turn drive rotation of a shaft 32. The shaft 32 may connect to a load 34, such as a generator that uses the torque of the shaft 32 to produce electricity. After passing through the turbine 26, the hot combustion gases may vent as exhaust gases 36 into the environment by way of the exhaust section 28. The exhaust gas 36 may include gases such as carbon dioxide (CO₂), carbon monoxide (CO), nitrogen oxides (NOₓ), and so forth.

The exhaust gas 36 may include thermal energy, and the thermal energy may be recovered by a heat recovery steam generation (HRSG) system 37. In combined cycle systems, such as the power production system 10, hot exhaust 36 may flow from the gas turbine 26 and pass to the HRSG 37, where it may be used to generate high-pressure, high-temperature steam 50. The steam 50 produced by the HRSG 37 may then be passed through the steam turbine system 41 for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the power production system 10 may also include a controller 38. The controller 38 may be communicatively coupled to a number of sensors 42, a human machine interface (HMI) operator interface 44, and one or more actuators 43 suitable for controlling components of the system 10. The actuators 43 may include valves, switches, positioners, pumps, and the like, suitable for controlling the various components of the system 10. The controller 38 may receive data from the sensors 42, and may be used to control the compressor 20, the combustors 22, the turbine 26, the exhaust section 28, the load 34, the HRSG 37, the steam turbine system 41, and so forth.

In certain embodiments, the HMI operator interface 44 may be executable by one or more computer systems of the power production system 10. A plant operator may interface with the power production system 10 via the HMI operator interface 44. Accordingly, the HMI operator interface 44 may include various input and output devices (e.g., mouse, keyboard, monitor, touch screen, or other suitable input and/or output device) such that the plant operator may provide commands (e.g., control and/or operational commands) to the controller 38. Further, operational information from the controller 38 and/or the sensors 42 may be presented via the HMI operator interface 44. Similarly, the controller 38 may be responsible for controlling one or more final control elements coupled to the components (e.g., the compressor 20, the turbine 26, the combustors 22, the load 34, and so forth) of the industrial system 10 such as, for example, one or more actuators 43, transducers, and so forth.

In certain embodiments, the sensors 42 may be any of various sensors useful in providing various operational data to the controller 38. For example, the sensors 42 may provide flow, pressure, and temperature of the compressor 20, speed and temperature of the turbine 26, vibration of the compressor 20 and the turbine 26, as well as flow for the exhaust gas 36, temperature, pressure and emission (e.g., CO₂, NOₓ) levels in the exhaust gas 36, carbon content in the fuel 31, temperature of the fuel 31, temperature, pressure, clearance of the compressor 20 and the turbine 26 (e.g., distance between the rotating and stationary parts of the compressor 20, between the rotating and stationary parts of the turbine 26, and/or between other stationary and rotating components), flame temperature or intensity, vibration, combustion dynamics (e.g., fluctuations in pressure, flame intensity, and so forth), load data from load 34, output power from the turbine 26, and so forth. The sensors 42 may also include temperature sensors such as thermocouples, thermistors, and the like, disposed in the steam turbine system 41. The sensors 42 may also include flow sensors such as flowmeters (e.g., differential pressure flowmeters, velocity flowmeters, mass flowmeters, positive displacement flowmeters, open channel flowmeters) and liquid level sensors such as continuous level transmitters, ultrasonic transducers, laser level transmitters, and so on, disposed in the steam turbine system 41. Additionally, the sensors 42 may include pressure sensors such as piezo-resistive pressure sensors, differential pressure sensors, optical pressure sensors, and so on, included in the steam turbine system 41. Actuators 43 may include pumps, valves, linear actuators, switches, and the like.

The controller 38 may include a processor(s) 39 (e.g., a microprocessor(s)) that may execute software programs to control the power production system 10. Moreover, the processor 39 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 38 may include a memory device 40 that may store information such as control software, look up tables, configuration data, etc.

The memory device 40 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 40 may store a variety of information, which may be suitable for various purposes. For example, the memory device 40 may store machine-readable and/or processor-executable instructions (e.g., firmware or software) for the processor execution.

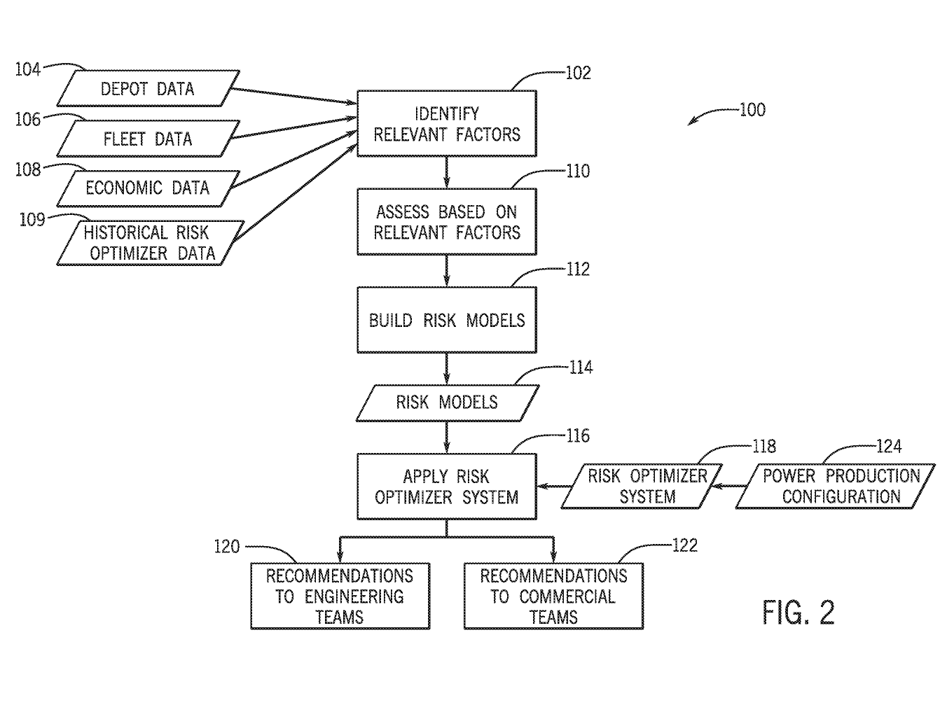

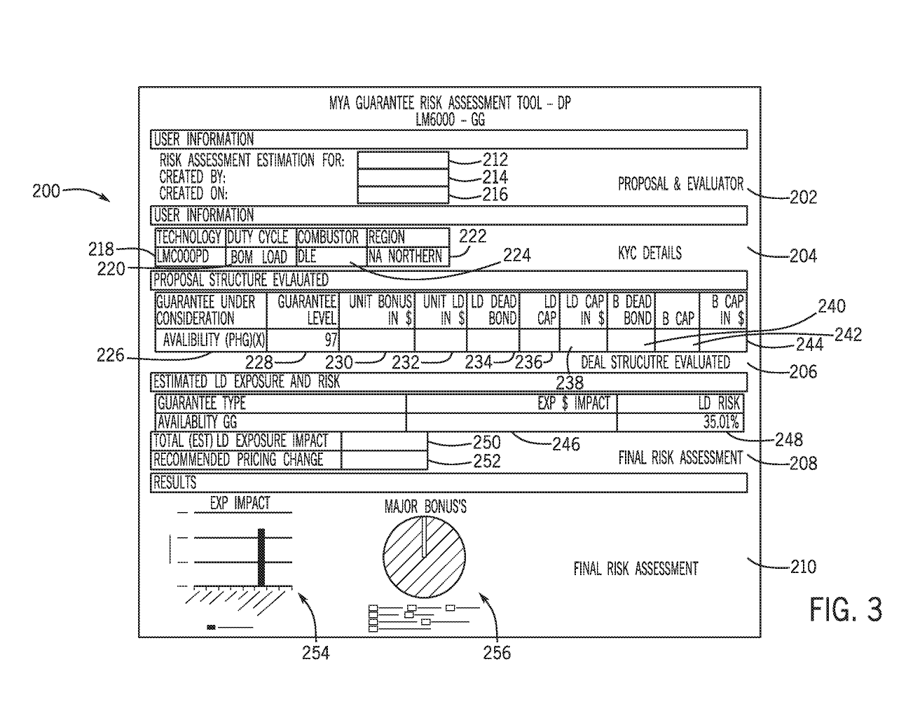

An analysis system 90 may be communicatively coupled to the controller 38, to the sensors 42, and/or actuators 43. The analysis system 90 may include one or more computing devices 92, each computing device 92 having one or more processors 94 and one or more memory devices 96. The processor(s) 94 may include multiple microprocessors, one or more “general-purpose” microprocessors, one or more special-purpose microprocessors, and/or one or more application specific integrated circuits (ASICS), or some combination thereof. For example, the processor 94 may include one or more reduced instruction set (RISC) processors. The processor(s) 94 may be used to execute certain of the techniques described herein, such as a process illustrated in FIG. 2 and a graphical user interface (GUI) illustrated in FIG. 3.

The memory device 96 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 96 may store a variety of information, which may be suitable for various purposes. For example, the memory device 96 may store machine-readable and/or processor-executable instructions (e.g., firmware or software) for the processor execution.

The techniques described herein enable, for example, a manufacturer of the power production system 10 to design a specific power production system 10 by selecting one or more systems or components targeted towards a specific client's needs, and then derive certain probabilities associated with implementing the design, as well as certain financial derivations useful for determining if a CSA would be profitable once the design was implemented and delivered, as described in more detail below. For example, the power production system 10 may include turbine systems and components available from General Electric Co., headquartered in Schenectady, N.Y. The turbine systems may include the LM series of aeroderivative turbines, such as the LM 2500, the LM 5000, the LM 6000, and so on.

FIG. 2 is a flowchart of an embodiment of a process 100 suitable for deriving certain risk models and applying the risk models to improve the design, implementation, and/or contracting of the power production system 10. The process 100 may be implemented as executable code instructions stored on a non-transitory tangible computer-readable medium, such as the volatile or non-volatile memory of a computer or a computer system, such as the memories 40 and/or 96, and may be executed via the processors 39 and/or 94.

In the depicted embodiment, the process 100 may identify (block 102) relevant factors. For example, factors that impact performance and operational reliability across a fleet of gas turbines 12, steam turbines 41, HRSG 37, the load 34 and so on, may be identified based on their impact. Factors for identification may include geographic location, weather (e.g., moistures, temperatures, ambient pressures), electric grid type (e.g., 60 Hz, 50 Hz), fuel type, number of certain components (e.g., fuel nozzles, combustors, electrical generators), type of the components (e.g., dry low emission [DLE] combustor, can combustor, cannular combustor, annular combustor, etc.), age of the components (e.g., in fired hours), operator for the power production system 10 (e.g., utility), and so on.

Data for the identification of relevant factors may include depot data 104, fleet data 106, economic data 108, and/or historical risk optimizer data 109. The depot data 104 may include service logs from depots or service centers that provide, for example, maintenance services for the various systems and components of the power production system 10. For example, turbine service centers may provide depot data having component wear and tear data for various operating fired hours, component failure rates, costs for repairs, service times for repairs, lead times for procurement of parts, and so on. Fleet data 106 may include log data for a fleet of systems or components of the power production system 10. The log data may detail number of fired hours, number of starts/stops, number of trips (e.g., fast shutdowns), operating performance (e.g., power produced in megawatts, fuel usage, speeds [e.g., operating RPM]), temperatures during operations, pressures during operations, fluid flow rates during operations, clearances (e.g., distance between moving and stationary components), fuel types, fuel composition, exhaust properties (e.g., chemical composition, pollutant measures), and so on, which may be gathered via the sensors 42.

The economic data 108 may include past contractual data for the fleet of systems or components of the power production system 10, historical and current energy market data (e.g., prices per megawatt, transmission costs, energy spot prices), “green” energy credits, design and/or manufacturing costs for the systems or components of the power production system 10, hedge costs, and so on. The historical data 109 may include previous inputs, derivations, and/or results from a risk optimizer system 118 described in more detail below.

The process 100 may then assess or analyze (block 110) historical reliability for the systems and components of the power production system 10, “uptimes” (e.g., availability for operations) for the systems and components of the power production system 10, overhaul restoration entitlements for the systems and components of the power production system 10, cost for providing CSA for a specific design or configuration of the power production system 10, and so on. The process 100 may then build (block 112) one or more risk models 114.

The risk models 114 may include mathematical models, and so on, that may take as input a desired configuration of the power production system 10 and/or systems or components of the power production system 10 (e.g., gas turbine 12, steam turbine 41, load 34, and/or HRSG 37) and provide as output certain probabilities or risks. For example, the probabilities or risks may include the probability that the gas turbine 12, steam turbine 41, load 34, and/or HRSG 37 operates at a baseload for a certain number of fired hours, probabilities related to reliability of the power production system 10 and/or systems or components of the power production system 10, economic risks of entering into a specific CSA, risks of not meeting certain guarantee levels, and so on.

The physics-based models may include low cycle fatigue (LCF) life prediction models, computational fluid dynamics (CFD) models, finite element analysis (FEA) models, solid models (e.g., parametric and non-parametric modeling), and/or 3-dimension to 2-dimension FEA mapping models that may be used to predict the risk of equipment malfunction or the need for equipment maintenance. AI models may also include expert systems (e.g. forward chained expert systems, backward chained expert systems), neural networks, fuzzy logic systems, state vector machines (SVMs), inductive reasoning systems, Bayesian inference systems, genetic algorithms (GA) or a combination thereof. Statistical models may include inferential statistics models such as linear regression models, non-linear regression models, analysis of variance (ANOVA) models, chi-squared test models, correlation models, time series analysis, models, and so on. Econometric models may include statistical, AI, math-based, and other models that may convey causal and/or counterfactual conditional (e.g., conditional containing an if-clause), evaluations of economic questions, such as “if the CSA's price is X then our profit based on risk R is approximately Y.”

The process 100 may then apply (block 116) the risk optimizer system 118 that may execute the risk models 114 to derive certain recommendations 120 to engineering teams and/or recommendations 122 to commercial teams. The risk optimizer system 118 may include computer instructions or software that take as input a given power production system 10 configuration or design 124, such as a specific configuration for the power production system 10, and/or any system or component of the power production system 10 to be sold to a customer (e.g., power utility). The power production configuration 124 may thus include model types for the gas turbine system 12, the steam turbine system 41, the HRSG 37, and/or the load 34, a given power production in megawatts, fuel types to be used, a reliability percentage, and so on. The power production configuration 124 may additionally or alternatively include a geographic region that the power production system 10 will be installed in, environmental properties (e.g., ambient pressures, temperatures, humidity), type of customer (e.g., utility, industrial, governmental), and the like. The power production configuration 124 may additionally or alternatively include contracting details such as a guarantee level to be provided by the manufacturer of the power production system 10, and/or any system or component of the power production system 10, reliability levels, bonuses for arriving at certain performance and/or operations metrics, penalties for not providing certain performance and/or operations metrics, costs to be charged for depot services, and so on.

The process 100 may then use the risk models 114 and the power production configuration 124 as input to the risk optimizer system 118 when applying (block 116) the risk optimizer system 118. The recommendations 120 to engineering teams may include recommendations to improve the life (e.g. life in fired hours) for the power production system 10, and/or any system or component of the power production system 10, to improve reliability of certain systems or components of the power production system 10, to improve efficiency (e.g., operations efficiency) for the power production system 10, and/or any system or component of the power production system 10, to improve manufacturing (e.g., manufacturing efficiency, manufacturing cost, procurement, etc.) for the power production system 10, and/or any system or component of the power production system 10, and the like. For example, the recommendation 120 may include a list of components for the gas turbine 12, the

The recommendations 122 to commercial teams may include a risk (e.g., 0% risk to 100% risk) of entering into a specific CSA that may be specified via the configuration 114, a return on investment (ROI) analysis of entering into the CSA, an expected profit or loss of entering into the CSA, an exposure impact of entering into the CSA, a recommended pricing change (e.g., change to derive a profit), and so on. The inputs (e.g., configuration 124) and outputs (e.g., recommendations 120, 122) used in applying (block 116) the risk optimizer system 118 may then be stored in the historical risk optimizer data 109 for feedback use in newer analysis. In this manner, a more efficient and profitable power production system 10 may be realized.

FIG. 3 is a screen view of a graphical user interface (GUI) 200 that may be used to interact with the risk optimizer system 118 of FIG. 2. It is to be understood that the GUI 200 is for simplified example only, and other interfaces may provide, for example, for the creation of the power production configuration 124 and for the execution of the risk models 114 via the risk optimizer system 118. The GUI 200 may be stored in the memories 40 and/or 96 and executed by the processors 38 and/or 94.

The depicted embodiment of the GUI 200 may include a proposal & evaluation name section 202, a Know Your Customer (KYC) details section 204, a deal structure to be evaluated section 206, a numerical final risk assessment section 208, and a graphical final risk assessment section 210. The proposal evaluator name section 202 may include input fields 212, 214, 216 suitable for entering names of who the outputs are being created for, by whom, and at what date, respectively. The KYC details section 204 may include input fields 218, 220, 222, 224 suitable for entering one or more systems, components of the power production system 10, and/or further details for the systems/components (e.g., input field 218), a duty cycle (e.g., field 220), a combustor type (e.g., field 222), a region that the power production system 10 may be located in (e.g., field 224), and the like.

The deal structure to be evaluated section 206 may include input fields 226, 228, 230, 232, 234, 236, 238, 240, 242, and 244 suitable for inputting a guarantee type under consideration, a guarantee level, a unit bonus in dollars, a unit liquidated damages (LD) in dollars, a LD dead band, a LD cap, a LD cap in dollars, a B deadband, a B cap, and a B cap in dollars, respectively. Once a user has inputted the configuration 124, for example, via certain GUI sections, such as sections 202, 204, and/or 206, the user may run an analysis and receive derivations suitable for providing certain risks. For example, as shown in the figure, sections 208 and 210 provide certain output risks. More specifically, section 208 provide for numeral risks such as an expected dollar impact (e.g., profit or loss) field 246, a LD risk percentage field 248, a total LD exposure impact field 252 and/or a recommended pricing change field 252. The section 210 may include graphics suitable for presenting risks, such as a bar code graph of risk 254 and a pie chart of risk 256.

Technical effects of the invention include the ability to improve a configuration or design and/or an operational life of turbomachinery, such as a gas or steam turbine system, a steam turbine system, a heat recovery steam generator (HRSG), and/or a load (e.g., electrical generator). A process and a system are provided that includes technical analysis as well as commercial analysis of certain data to derive risks associated with operations of the turbomachinery at future periods (e.g., fired hours, number of starts), reliability, and contractual agreements such as contractual service agreements (CSAs). Accordingly, design and implementation of the turbomachinery may be improved.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a processor configured to:
identify relevant factors related to a configuration of a power production system comprising a gas turbine system based at least on a fleet data for a fleet of the gas turbine system;
build one or more risk models configured to derive a probability of achieving a performance level for the configuration based on the relevant factors; and
execute the risk models to derive an engineering recommendation, a commercial recommendation, or a combination thereof.

2. The system of claim 1, wherein the commercial recommendation comprises a risk of entering into a contractual service agreement (CSA) to implement the configuration of the power production system in a specific geographic region.

3. The system of claim 2, wherein the commercial recommendation comprises a recommended pricing change to the CSA based on the risk of entering into the CSA.

4. The system of claim 2, wherein the commercial recommendation comprises an expected dollar impact, an expected exposure impact, or a combination thereof, of entering into the CSA.

5. The system of claim 1, wherein the engineering recommendation comprises a first list of subsystems, components, or a combination thereof, of the gas turbine, having an operating life below a number of fired hours, a second list of subsystems, components, or a combination thereof, of the gas turbine, having a reliability below a reliability measure, or a combination of the first and the second list.

6. The system of claim 1, wherein the processor is configured to identify relevant factors related to the configuration of the power production system based at least on the fleet data, a depot data, an economic data, a historical risk data, or a combination thereof.

7. The system of claim 1, wherein the risk models comprise econometric models, physics-based models, statistical models, artificial intelligence (AI) models, or a combination thereof.

8. The system of claim 1, wherein the configuration of the power production system comprises the gas turbine system and;
a steam turbine system, a heat recovery steam generator (HRSG), an electric generator, or a combination thereof, and wherein the HRSG is diposed downstream of an exhaust section of the gas turbine system, the steam turbine system is configured to received heated steam from the HRSG, and wherein the electrric generator is mechanically coupled to the gas turbine system or to the steam turbine system and configured to produce electric power.

9. The system of claim 1, wherein the processor is configure to execute the risk models via a risk optimizer system.

10. The system of claim 9, wherein the risk optimizer system comprises a graphical user interface (GUI) comprising:
an evaluation name input section; a configuration details input section; a deal structure to be evaluated input section; a numerical risk assessment output section; a graphical risk assessment output section; or a combination thereof.

11. A method, comprising:
identifying, via a processor, relevant factors related to a configuration of a power production system comprising a gas turbine system based at least on a fleet data for a fleet of the gas turbine system;
building, via the processor, one or more risk models configured to derive a probability of achieving a performance level for the configuration based on the relevant factors; and
executing, via the processor, the risk models to derive an engineering recommendation, a commercial recommendation, or a combination thereof.

12. The method of claim 11, wherein the commercial recommendation comprises a risk of entering into a contractual service agreement (CSA) to implement the configuration of the power production system in a specific geographic region.

13. The method of claim 12, wherein the commercial recommendation comprises a recommended pricing change to the CSA based on the risk of entering into the CSA.

14. The method of claim 13, wherein the commercial recommendation comprises an expected dollar impact, an expected exposure impact, or a combination thereof, of entering into the CSA.

15. The method of claim 11, wherein the engineering recommendation comprises a first list of subsystems, components, or a combination thereof, of the gas turbine, having an operating life below a number of fired hours, a second list of subsystems, components, or a combination thereof, of the gas turbine, having a reliability below a reliability measure, or a combination of the first and the second list.

16. The method of claim 11, wherein executing, via the processor, the risk models comprises executing the risk models via a risk optimizer system, wherein the risk optimizer system comprises a graphical user interface (GUI) comprising:
an evaluation name input section; a configuration details input section; a deal structure to be evaluated input section; a numerical risk assessment output section; a graphical risk assessment output section; or a combination thereof.

17. A non-transitory computer readable medium, comprising instructions that when executed by a processor, cause the processor to:
identify relevant factors related to a configuration of a power production system comprising a gas turbine system based at least on a fleet data for a fleet of the gas turbine system;
build one or more risk models configured to derive a probability of achieving a performance level for the configuration based on the relevant factors; and
execute the risk models to derive an engineering recommendation, a commercial recommendation, or a combination thereof.

18. The non-transitory machine readable media of claim 17, wherein the commercial recommendation comprises a risk of entering into a contractual service agreement (CSA) to implement the configuration of the power production system in a specific geographic region.

19. The non-transitory machine readable media of claim 16, wherein the commercial recommendation comprises a recommended pricing change to the CSA based on the risk of entering into the CSA, an expected dollar impact of entering into the CSA, an expected exposure impact of entering into the CSA, or a combination thereof.

20. The non-transitory machine readable media of claim 17, wherein the engineering recommendation comprises a first list of subsystems, components, or a combination thereof, of the gas turbine, having an operating life below a number of fired hours, a second list of subsystems, components, or a combination thereof, of the gas turbine, having a reliability below a reliability measure, or a combination of the first and the second list.
